(19) United States
(12) Patent Application Publication
(10) Pub. No.: US 2026/0185851 A1
(43) Pub. Date: Jul. 2, 2026

(54) Processing Digital Map Data

(71) Applicant: TomTom NAVIGATION B.V., Amsterdam (NL)

(72) Inventors: Johannes Michaël Van Hulst, Amsterdam (NL); Rui Sun, Elst (NL); Sebastien Salles, Amsterdam (NL); Kees van Boxel, Drunen (NL); Nicolas Gerber, Amsterdam (NL)

(21) Appl. No.: 18/797,177

(22) PCT Filed: Feb. 7, 2023
(86) PCT No.: PCT/EP2023/053014

§ 371 Date: Aug. 7, 2024

(30) Foreign Application Priority Data
Feb. 18, 2022 (GB) 2202231.3

(51) Int. Cl. G01C 21/00

(52) U.S. Cl. CPC G01C 21/3889; G01C 21/3896

(57) ABSTRACT

The application describes a method for generating a subset of an electronic map describing a road network in an area. The generation process reduces the number of road segments and the number of attributes associated with these road segments. The map data subset generation enables optimisation of the bandwidth and request rate to provide relevant information to a client application processing the map data subset.

### BACKGROUND OF THE INVENTION

This invention relates to methods, apparatus and software for processing digital map data.

It is known to generate, maintain and distribute digital map information for use in navigation systems, advanced driving application systems, and automated driving application systems. For road vehicles, digital map data may describe a road network in an area (e.g. a country), represented as a graph comprising arcs (i.e. edges) representing road segments, and vertices (i.e. nodes) representing connections, such as junctions, exits and end points. Each arc and node in the map may be associated with one or more attributes that describe a feature of the road segment or the connection point. The features may be abstract or physical, such as average speed of travel, legal speed limit, direction of travel, length of the road segment, average turn time for a junction, shape of the road segment, or number of lanes. These attributes may be used by a variety of applications that operate based on the map data.

One exemplary system that can make use of digital map data is Intelligent Speed Assist (ISA) in motor vehicles. The European Union safety regulation 2019/2144 mandates in Article 6 the inclusion of ISA in motor vehicles (cars, motorcycles, trucks) from the year 2022. The regulation states that an ISA system in a vehicle may operate on speed limit information that it obtains through observation of road signs and signals, or from road infrastructure signals, or from electronic map data. Additionally, the regulation states that the ISA system shall avoid or minimise the error rate under real driving conditions.

The process of obtaining the legal speed attribute from digital map data, for a map-matched location of a vehicle (i.e. a location expressed in terms of digital map elements), is implemented in existing navigation systems, such as in-vehicle satellite navigation devices and smartphone apps. However, the transmission of such legal speed attribute data to a client device is typically data intensive.

It is therefore desirable for the transmission of digital map data, such as speed limit information, to make efficient use of communication resources, especially when, for example, it is provided over a mobile telecommunication infrastructure, or a vehicle-to-vehicle communication infrastructure, or a communication network in a car, where bandwidth may be limited and/or costly.

WO 2014/068094 A1 by TomTom International B.V. discloses using the current location of a vehicle and digital map data to determine a “horizon”, containing a collection of road segments, corresponding to paths within a predetermined distance or radius ahead of the vehicle, which the vehicle might traverse in the immediate future. Attribute data, such as a speed limit associated with a road segment, may be transmitted over an internal vehicle bus to an Advanced Driver Assistance System, for paths contained in the horizon.

The use of such a horizon can reduce the amount of digital map data to be transmitted. However, embodiments of the present invention aim to provide further efficiencies.

### SUMMARY OF THE INVENTION

A method for sending map related data to a client apparatus, wherein the map-related data is extracted from digital map data representative of a network of navigable path segments within a geographic area, the method comprising:
receiving probability data for a subject vehicle at a location, wherein, for each of a plurality of the path segments of the digital map data, the probability data represents a respective probability of the subject vehicle traversing the respective path segment;
determining a set of one or more paths, each path comprising one or more of the plurality of path segments and having a respective determined extent, wherein the determined extent of at least one of the paths depends at least in part upon the received probability data;
extracting data, associated with the determined set of one or more paths, from the digital map data in accordance with the respective determined one or more path extents; and
sending the extracted data to the client apparatus.

From a second aspect, the invention provides a computer processing system for sending map-related data to a client apparatus, wherein the map-related data is extracted from digital map data representative of a network of navigable path segments within a geographic area, and wherein the computer processing system is configured to:
receive probability data for a subject vehicle at a location, wherein, for each of a plurality of the path segments of the digital map data, the probability data represents a respective probability of the subject vehicle traversing the respective path segment;
determine a set of one or more paths, each path comprising one or more of the plurality of path segments and having a respective determined extent, wherein the determined extent of at least one of the paths depends at least in part upon the received probability data;
extract data, associated with the determined set of one or more paths, from the digital map data in accordance with the respective determined one or more path extents; and
send the extracted data to the client apparatus.

From a third aspect, the invention provides computer software comprising instructions which, when executed on a computer processing system, cause the computer processing system to send map-related data to a client apparatus, wherein the map-related data is extracted from digital map data representative of a network of navigable path segments within a geographic area, by:
receiving probability data for a subject vehicle at a location, wherein, for each of a plurality of the path segments of the digital map data, the probability data represents a respective probability of the subject vehicle traversing the respective path segment;
determining a set of one or more paths, each path comprising one or more of the plurality of path segments and having a respective determined extent, wherein the determined extent of at least one of the paths depends at least in part upon the received probability data;
extracting data, associated with the determined set of one or more paths, from the digital map data in accordance with the respective determined one or more path extents; and sending the extracted data to the client apparatus.

Thus it will be seen that, in accordance with embodiments of the invention, the extent (i.e. length) of at least one of the paths in the set (which may define a virtual “horizon” for the vehicle), for which data is extracted, varies depending on the likelihood of the vehicle traversing the various path segments. The size of the data that is extracted may thus vary in response to the relative likelihoods of each path being traversed. This approach may increase the expected time over which the vehicle will remain within the defined horizon, without having to increase the volume of map data to be transmitted, stored and/or processed. This can allow embodiments to make particularly efficient use of communication bandwidth when sending the extracted data (e.g. when transmitting the extracted data over a telecommunications network from a remote server to a client apparatus that is carried by, or that is part of, the subject vehicle).

In contrast to the horizon of WO 2014/068094 A1, which is defined to have a fixed distance or radius, the extent (i.e. distance) of at least one path in embodiments disclosed herein can vary in dependence not only on the layout of the map but also on the probabilities of the vehicle traversing the path segments that make up the path or paths.

Any or all of the steps of receiving, determining, extracting and sending may be performed by a server, which may be remote from the client apparatus and/or the subject vehicle.

Each path may comprise a contiguous sequence of path segments. Each path segment may be a straight line or a polyline. Some or all of the paths may be partially overlapping—i.e. may share one or more path segments in common. The probabilities for path segments leading away from a common node (e.g. from a junction) may sum to one, although this is not necessarily the case for all nodes, e.g. as some path segments may not be selected for inclusion in the set of paths.

In some embodiments or in some situations, the system may determine an extent for only a single path, in dependence on the probability data, and may extract the map-related data in accordance with the extent of this single path. However, in other embodiments and other situations, the set of paths may comprise a plurality of paths, and the extracted data may be determined based on the extents of the plurality of paths.

The method may comprise determining which paths to include in the set of paths. This may be determined at least partly in dependence upon the received probability data. It may be determined at least partly in dependence upon the location of the vehicle. The set of paths may generated constructively (e.g. by progressively adding paths to the set), or it may be determined by filtering a larger set of possible paths. On occasions, a path may be determined to have a null (e.g. zero) extent; this may be equivalent to that path being excluded from the set of one or more paths. The extracted data may contain only digital map data associated with paths of the set of one or more paths.

The location of the vehicle is preferably in the geographic area covered by the digital map data. The location of the vehicle may be determined from probe data (e.g. GNSS data), e.g. generated by a position-sensing system in or of the subject vehicle. The geographic location of the subject vehicle may be matched to a location of the vehicle in the network of navigable path segments, e.g. using probe data comprising one or more GNSS locations and/or headings. This map-matching could be done by client apparatus on the vehicle, but is preferably done by the server.

In some embodiments, the received probability data may directly represent the path-segment probabilities (e.g. as encoded values). However, in other embodiments the received probability data represent the path-segment probabilities indirectly—e.g. by comprising data from which they can be calculated. For instance, the probability data may, in some embodiments, comprise turn probabilities at connections between path segments. These turn probabilities may optionally be particular to the subject vehicle. Some embodiments comprise processing the received probability data to calculate a respective probability (i.e. likelihood) of the subject vehicle traversing each of the path segments of a path of the set of one or more paths. This processing may take account of how the subject vehicle reached the location. In some embodiments, the determined probability of the subject vehicle traversing a particular path segment may depend on a sequence of path segments traversed by the subject vehicle to arrive at the path segment (i.e. to reach a connection at a start of the path segment). This sequence may be at least partly hypothetical (e.g. relating to future travel by the subject vehicle). The turn probabilities may be associated with road features such as roundabouts, cross-roads or junctions. They may be received as part of the received probability data.

Some embodiments comprise processing the received probability data to calculate a respective probability of the subject vehicle traversing a path of the set of one or more paths (i.e. up to the determined extent for the path).

The set of paths may include a most probable path (MPP), being a path whose road segments have a highest cumulative probability out of every possible path subject to one or more constraints (e.g. subject to a maximum extent). The set of paths may include a primary path and zero, one, or more alternative paths. Each alternative path may branch off the primary path at the present vehicle location or at a connection point farther along the primary path.

In some embodiments, the extent of at least one path of the set of paths (e.g. of a most probable path of the set of paths), and optionally of all of the paths, may be determined at least partly based on a minimum path-probability threshold. The minimum path-probability threshold may be predetermined, e.g. being fixed. The same threshold may be used to determine the extents of each of the set of paths. The extent may be determined such that the probability of the vehicle traversing the path (i.e. staying on the path) for the determined extent is close to the minimum path-probability threshold. The probability may be considered close to the threshold when the addition or the removal of one path segment would cause the probability of the resulting path to cross the threshold. The extent of the path may be determined by iteratively adding path segments to the path until the path probability crosses below the minimum path-probability threshold and then ceasing to add any further path segments to the path.

In some embodiments, the extents of the set of paths may be determined at least partly based on a minimum horizon-probability threshold. The minimum horizon-probability threshold may be predetermined, e.g. being fixed. The extents may be determined such that the probability of the vehicle traversing any path of the set for the respective extent of the path is close to the minimum horizon-probability threshold. The probability may be close to the threshold when the addition or the removal of one path segment from the set of paths would cause the cumulative probability for the set of paths to cross the threshold.

In some embodiments, the extent of at least one path of the set of paths (e.g. of a most probable path of the set of paths), and optionally of all of the paths, may be determined at least partly based on a maximum path-distance threshold. The maximum path-distance threshold may be predetermined, e.g. being fixed, or it may be calculated dynamically, e.g. based on a speed of the vehicle. The same threshold may be used to determine the extents of each of the set of paths. The extent may be determined such that it is close to the maximum path-distance threshold. The path extent may be considered close to the threshold when the addition or the removal of one path segment would cause the extent of the resulting path to cross the threshold. The extent of the path may be determined by iteratively adding path segments to the path until the extent of the path crosses above the maximum path-distance threshold and then ceasing to add any further path segments to the path.

Some embodiments may determine the membership (i.e. which paths are included) and extents of the set of paths using both a maximum path-distance threshold for each path and a minimum horizon-probability threshold for the set of paths. Each path of the set may be extended using an iterative extension process until the path has a distance close to the maximum path-distance threshold, and the number of paths in the set of paths may be determined using the minimum horizon-probability threshold. Paths may be added to the set of paths until the probability of the vehicle traversing any path of the set for the respective extent of the path is close to the minimum horizon-probability threshold. The probability may be close to the threshold when the addition or the removal of one path from the set of paths would cause the cumulative probability for the set of paths to cross the threshold.

In some embodiments, the extents of each of the set of paths may be determined at least partly based on a maximum data-volume threshold. The maximum data-volume threshold may be predetermined, e.g. being fixed. The extents may be determined such that the extracted data is below the maximum data-volume threshold.

In some embodiments, the extents of each of the set of paths may be determined at least partly based on a target request rate. The target request rate may be predetermined, e.g. being fixed. The target request rate may be used to determine a maximum path-distance threshold, as described above. The maximum path-distance threshold may be determined at least partly on a speed of the vehicle.

More generally, the extent of at least one path of the set of paths may be determined at least partly in dependence upon a speed of the vehicle (e.g. its current speed).

The extracted data may be transmitted to the subject vehicle over a data network. It may be transmitted at least partly wirelessly, e.g. by radio. It may be sent over a cellular telecommunications network.

The server and client apparatus could be provided by a common apparatus or device (e.g. with the sending occurring over an internal interface). However, in other embodiments, the data may be extracted by a server, remote from the vehicle (e.g. a static server). It may be received by a client apparatus in the vehicle, which may be in-built or otherwise located within the vehicle (e.g. comprising a smartphone of a driver). The client apparatus may be or comprise the subject vehicle, or a processing system of the subject vehicle.

In some embodiments, a server remote from the vehicle may send the extracted data to an intermediate device (e.g. a smartphone in the vehicle), which may then further transmit some or all of the data to a processing system of the subject vehicle (e.g. via Bluetooth).

In some embodiments, the determining of the set of one or more path and/or the extracting of the data and/or the sending of the extracted data may be performed by a standalone processing device such as smartphone or a self-contained satellite navigation unit.

In some embodiments, the determining of the set of one or more path and/or the extracting of the data and/or the sending of the extracted data may be performed by a digital-map processing system of the subject vehicle (i.e. integrated within the vehicle). The client apparatus may be a further processing system or a navigation system in or of the same subject vehicle. The data may be sent over an electrical, optical or wireless connection within the vehicle.

Extracting map data in accordance with the respective path extents may comprise extracting data associated with some or all path segments up to the respective determined extent of each path in the

The extracted data may comprise attribute data associated with one or more path segments of the one or more paths, preferably relevant to an intended use of the extracted data. It may comprise speed-limit data. It may comprise attribute data for all of the determined extent of each path.

The probability data may be generated using a machine-learning model trained on historic trip data.

The extracted data may represent a portion of the network of navigable path segments (e.g. path segment identifiers or geographic data) as well as attribute data for the determined set of one or more paths.

A validity distance or validity time may be determined for the extracted data, over which an attribute of the map data (e.g. a speed limit) is constant. Validity distances may be used to simplify the extracted data where an attribute does not change along one or more contiguous path segments. These contiguous path segments may be merged into a single element in the extracted data, for sending to the client apparatus.

An updated set of data may be extracted (e.g. a new virtual horizon may be generated) when the vehicle has reached, or is within a predetermined distance of, the end of a path covered by the extracted data (i.e. such that travelling further would result in the vehicle's location being outside of the virtual horizon). The processing system on the server may generate a new set of one or more paths (i.e. a new virtual horizon) in response to determining that the location of the vehicle is outside the (current) set of one or more paths. Alternatively, the client apparatus may request a new set of extracted data from the server when the client apparatus determines this.

The path segments may be road segments. The vehicle may be road vehicle such as a car or truck.

Receiving data (e.g. probability data) may comprise retrieving the data from a memory (e.g. a memory of the processing system) or receiving it over a network connection.

Apparatus in the vehicle (e.g. a built-in processing system, or a portable device such as a smartphone) may communicate probe data (e.g. GNSS position data) to a server over a network (e.g. a radio network). It may receive the extracted data from the server. It may receive a succession of sets of extracted data in response to a respective succession of requests, each of which may comprise respective probe data.

In some embodiments, the extracted data may be used to determine information for outputting to a driver of the vehicle (e.g. visually and/or audibly) and/or to determine control data for controlling motion of the vehicle (e.g. to reduce the speed of the vehicle). The information may be assistance information. It may comprise speed limit information. The extracted data may be processed at least partly in the vehicle, e.g. in a computer system built into the car or in a smartphone or a satellite navigation device.

The methods disclosed herein may be at least partly computer-implemented. The computer software disclosed herein may be on a transitory or a non-transitory computer-readable medium. The model may be implemented on a single processing device (e.g. a server) or may be implemented across multiple processing devices, which may be in different geographical locations. The model may be implemented for use in inference mode on a computer processing system that is different from a computer processing system that was used to train the model.

The model may comprise any number of further convolution layers, dense blocks, and other processing layers, in addition to those described above. The model may comprise software instructions for one or more processors, or may comprise dedicated hardware logic, or may be implemented using a combination of software and application-specific hardware. The software may comprise instructions that are stored in a memory of the computer processing system. The computer processing system may comprise one or more of: CPUs, DSPs, GPUs, FPGAs, ASICs, volatile memory, non-volatile memory, inputs, outputs, displays, network connections, power supplies, radios, clocks, and any other appropriate components. It may comprise one or more servers or computers. It may comprise a microcontroller or system-on-chip (e.g. when implementing the trained model for inference operation). It may be configured to store or display or output the probability data.

Features of any aspect or embodiment described herein may, wherever appropriate, be applied to any other aspect or embodiment described herein. Where reference is made to different embodiments or sets of embodiments, it should be understood that these are not necessarily distinct but may overlap.

### BRIEF DESCRIPTION OF THE DRAWINGS

Certain preferred embodiments of the invention will now be described, by way of example only, with reference to the accompanying drawings, in which:

FIG. 1 is a digital map of part of a road network;

FIG. 2 is a schematic diagram of a first map-processing system embodying the invention;

FIG. 3 is the digital map of FIG. 1, highlighted to show a first virtual horizon;

FIG. 4 is the digital map of FIG. 1, highlighted to show a second virtual horizon;

FIG. 5 is the digital map of FIG. 1, highlighted to show a virtual horizon comprising a primary path and an alternative path determined using a probability threshold;

FIG. 6 is the digital map of FIG. 1, highlighted to show a virtual horizon comprising a primary path and an alternative path determined using probability and distance threshold values;

FIG. 7 is a schematic diagram of a second map-processing system embodying the invention;

FIG. 8 is a schematic diagram of a machine-learning system for generating probabilities, for use with some embodiments of the invention; and

FIG. 9 is a schematic diagram of a third map-processing system embodying the invention.

### DETAILED DESCRIPTION

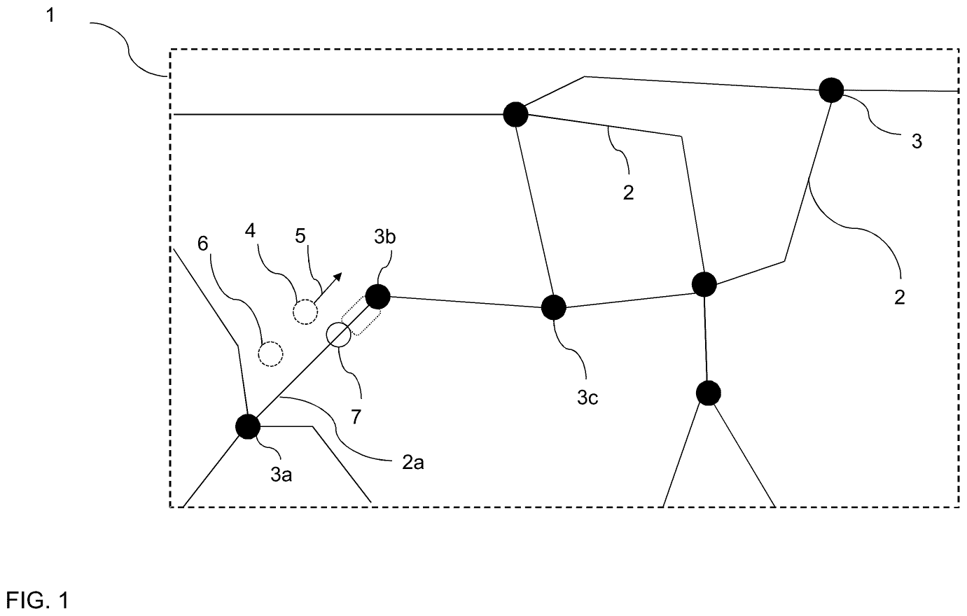

FIG. 1 shows part of a digital map of a road network, covering a map area 1, where the map is represented as a graph. The map data for the map area 1 comprises edges that represent road segments 2, and that connect nodes representing connections 3. For example, the road segment 2a links connections 3a and 3b. The connections 3 may represent road junctions, exits, end points, or locations at which an attribute of the road changes, such as a change of speed limit. A road segment 2 may be associated with attributes that describe information such as the average speed of travel, legal speed limit, direction of travel, length of a road segment, average turn time for a junction, shape of a road segment (e.g. a polyline comprising a sequence of geographic coordinates along the road segment), or number of lanes. To provide Intelligent Speed Assist (ISA) functionality, each road segment 2 (and optionally connection 3) may comprise a speed limit attribute that describes the legal speed limit for that road segment or connection.

The road segments 2 may be directed segments identified by unique path segment identifiers. The unique road segment identifier may be formed using geographical coordinates of the pair of connections at either end of a road segment in the order of travel. For example, one direction of traffic flow for road segment 2a may be represented by a start connection 3a and an end connection 3b, while traffic flow in the opposite direction for the same road segment 2a may be represented by the ordered pair of connections 3b and 3a.

FIG. 1 shows locations 4, 6 and a direction of travel 5 that are examples of probe data obtained from sensors (e.g. a GNSS sensor) on a vehicle. Probe data may encode a current location 4 and a current direction 5. Alternatively, the probe data may encode the current location 4 and a previous location 6, with the current direction of travel 5 inferred from the locations 4 and 6. This provides a more general direction of travel related to the probe data.

The location information of the probe data is obtained from a location (e.g. GPS) sensor, which has a detection error margin that causes the location information to not coincide with the road segments, as shown in FIG. 1. In the presence of location sensing errors, it is known to use a map-matching process to determine a map-matched location 7. Such a map-matching process obtains a sequence of measured locations 4, 6 and determines a current map-matched location 7 in the road network represented by the digital map, which may be expressed as a distance travelled along a road segment. Examples of map-matching processes that may be used are described in WO 2018/019984 A1 and WO 2018/019989 A1, both by TomTom Navigation B.V.

This map-matched location data may be updated at intervals as the vehicle travels—i.e. in real time. It is given as input to a service in order to retrieve map data about the upcoming path.

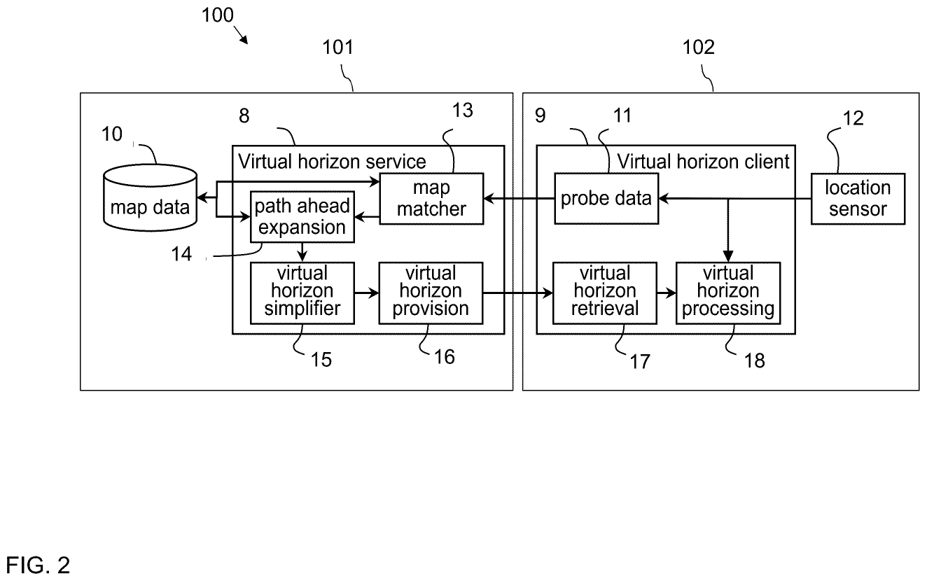

FIG. 2 shows a map-processing system 100 embodying the invention. It includes a server 101 and a client apparatus 102, arranged to communicate with each other. Communication may include one or more wired or wireless links, such as radio link (e.g. provided by a cellular network). It may occur over one or more private and/or public networks. The server 101 may be static, e.g. hosted in a server farm at a fixed location, and the client apparatus 102 may be mobile, e.g. being implemented on a smartphone, or being a standalone navigation device, or being built into a vehicle such as a car or truck. However, in other embodiments, the server 101 may also be on the vehicle, e.g. with all components being provided by a single smartphone executable, or built into the vehicle.

The server 101 executes software on one or more processors in order to provide a “virtual horizon” service 8. This service 8 retrieves, selects, and provides relevant map information in response to location-based probe data received from a “virtual horizon” client 9 executing on one or more processors of the client apparatus 102.

The term “virtual horizon” is used here merely as a convenient label, to express the concept of a limit (e.g. a boundary on a digital map), beyond which a device may have less information than it does for locations within the limit.

The virtual horizon service 8 accesses a database 10 storing digital map data, which may be similar to the data of which FIG. 1 shows an extract. The probe data is associated with a vehicle travelling within a road network represented by the digital map database. The virtual horizon client 9 comprises a probe data module 11 that obtains location data (e.g., a latitude and longitude) from a location sensor 12 such as a global navigation satellite system (GNSS) sensor attached to or located within the vehicle. The probe data module 11 may combine the location data with other data such as time, direction, speed, or previously generated probe data.

The probe data is sent by the client apparatus 102 to the server 101. A map-matcher module 13 of the virtual horizon service 8 receives the probe data and determines a current map-matched location 7 that best matches the received probe data for the current location 4 of the vehicle. The probe data may comprise additional information that helps the map-matcher module 13 to determine the current map-matched location 7. Probe data with two GNSS locations (longitude, latitude) and two headings can be sufficient for the map-matcher module 13 to decide which road to match. Using a longer travel history, comprising more than two locations, does not necessary provide a reasonable improvement to the overall accuracy of the map-matched location. Because a longer travel history requires an increased volume of probe data, at least some embodiments of the map-matcher module 13 process at most two locations, from the probe data, to determine a map-matched location 7.

The virtual horizon service 8 has a path ahead expansion module 14 that receives the current map-matched location 7 and optionally the probe data. The path ahead expansion module 14 determines path data representing one or more paths ahead of the current map-matched location 7 using the map data. The path data may at times represent a single unbranching path through the graph, while at times it may represent a plurality of paths, including a primary path and one or more alternative paths that branch off the primary path. Paths may branch at the current vehicle location (e.g. if the vehicle is at a junction), or at more distant points along a primary path (e.g. if the vehicle is not currently at a junction). An alternative path may provide map information relating to an alternative future location of the vehicle in the road network, not present on the primary path. Each path may be a contiguous sequence of one or more path segments. Each path has a respective total distance (i.e. an extent) that is equal to the sum of the lengths of all the path segments in the path. These extents may be determined explicitly (e.g. as a total distance values calculated by the expansion module 14) or may be determined only implicitly. The set of path extents defines the extent of the virtual horizon. The virtual horizon can be said to have a total distance that is equal to the minimum total distance of any of the paths in the virtual horizon. It may alternatively be said to have a total distance equal to the mean average of the total distances of all the paths in the virtual horizon. The total distance can be used as a way to estimate the frequency of requests for a new set of path data from the client associated with the subject vehicle. Using the minimum total distance for this gives a conservative estimate.

The expansion module 14 generates the path or paths of the virtual horizon based on probabilities associated with outgoing road segments at connection locations. This may be done in various ways, some of which are described in more detail below.

These probabilities may be assigned statically to each connection location—e.g. being determined analytically based on rules related to junction angles and road classes, or being determined empirically from historic trip data. They may be contained within the map data, and the expansion module 14 may receive corresponding probability data from the map database 10.

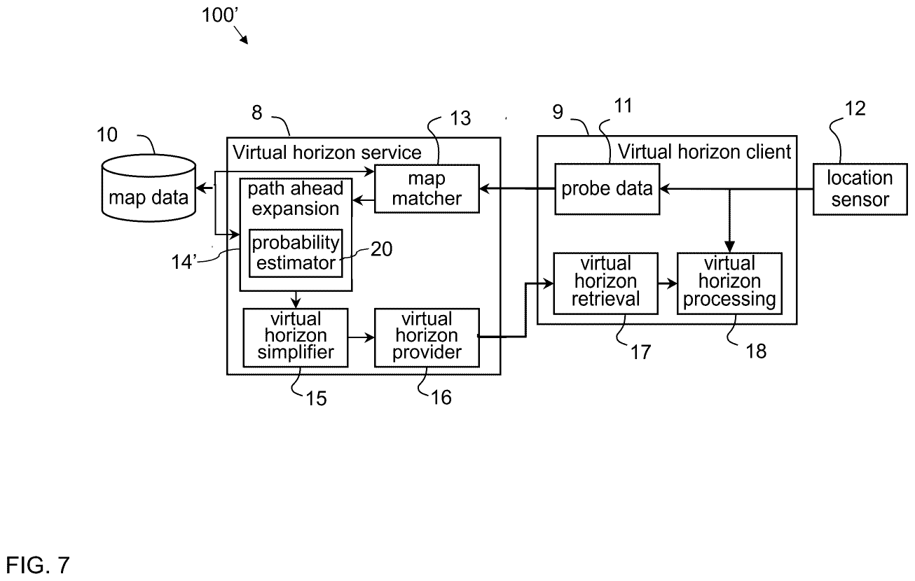

However, in other embodiments, the expansion module 14 may calculate the probabilities, in real time. Some such arrangements are explained in more detail below with reference to FIGS. 7-9. It may do so based on a general direction of travel, or other information in the probe data. It may determine the probabilities at least partly in dependence on the sequence of road segments traversed by a particular vehicle to reach the connection. The probabilities may be equal for every user (i.e. all vehicles and/or drivers), or they may be determined specifically for a particular vehicle and/or driver. The expansion module 14 may adjust universal probability data (e.g. received from the map database 10 or another source), applicable across a population of users, by applying one or more contextual factors such as time and/or the identity of the driver or vehicle.

The road segment identifiers included in the path data may include the geographical coordinates of the end points of each road segment, so that the client apparatus 102 can process them without requiring access to the map data. The path ahead expansion module 14 obtains a collection of map-data attributes associated with the path data (e.g. speed limit attribute, or a shape attribute) and combines the path data with the collection of attributes to form a dataset referred to here as a “virtual horizon”.

An optional virtual horizon simplifier module 15 of the virtual horizon service 8 receives the virtual horizon from the path ahead expansion module 14 and merges road segments for which the collection of attributes have the same values. The distance of these road segments having the same values can be referred to as the “validity distance”. For example, when the collection of attributes is a speed attribute, the virtual horizon simplifier module 15 merges subsequent road segments having a speed attribute with the same speed value. The merging step replaces the road shape attribute (e.g., a polyline) of the subsequent road segments into a single road shape attribute that has a length equal to the validity distance. The merged road segment is associated with the merged road shape attribute and the common speed attribute. This method of merging road segments could be applied to any attribute which is useful for the application. Road segments along a path in the virtual horizon can be merged if subsequent road segments have the same data values for a given attribute. The use of the virtual horizon simplifier module 15 therefore reduces the amount of data in the virtual horizon and makes it easier to process the information contained in the virtual horizon in the virtual horizon client 9.

A virtual horizon provision module 16 of the virtual horizon service 8 receives the (optionally simplified) virtual horizon and transmits the virtual horizon to the virtual horizon retrieval module 17 of the virtual horizon client 9. The virtual horizon retrieval module 17 obtains the virtual horizon as a response to the probe data transmitted by the probe data module 11.

A virtual horizon processing module 18 executing on the client apparatus 102 obtains the received virtual horizon from the virtual horizon retrieval module 17. The virtual horizon processing module 18 processes the virtual horizon and matches the GNSS inputs from the location sensor 12 to the road shape attribute associated with the path or paths of the virtual horizon, as the vehicle travels along a path. It also generates output data from the collection of attributes (e.g. representative of the current speed limit), associated with the current path and/or an alternative path of the virtual horizon, using the position data from the location sensor 12, which it may display on a display unit to a driver of the vehicle and/or send to a control system of the vehicle (e.g. to an automatic speed limiter system).

The virtual horizon processing module 18 receives and monitors the GNSS sensor data to determine that the vehicle associated with the virtual horizon client remains on a path of the virtual horizon. It may use trigger mechanisms to determine that the client has deviated from a path of the virtual horizon. Examples of such triggers could include the client being a threshold distance removed from the paths in the virtual horizon, or the detected heading for the client exceeding a threshold difference with the heading as encoded in a path of the virtual horizon. When a deviation is deemed to have occurred, the virtual horizon client 9 requests a new virtual horizon from the virtual horizon service 8, by sending updated probe data to the service 8.

Instead of sending a fixed radius of map data for the map area around the current location 4, the system uses the current map-matched location 7 to determine a virtual horizon from the map data in the area surrounding the current map-matched location 7.

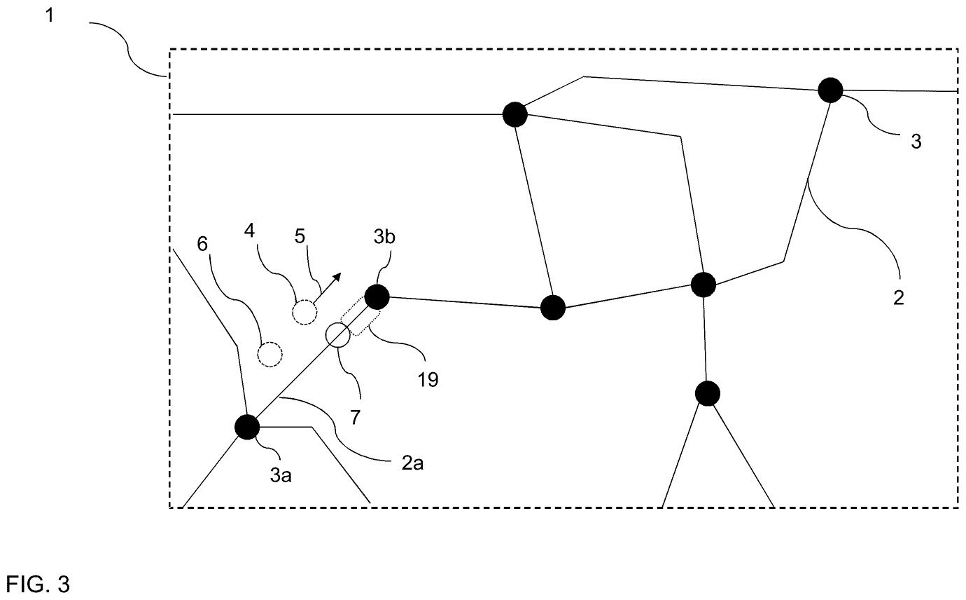

FIG. 3 shows an exemplary virtual horizon 19, overlaid on the map extract of FIG. 1. The virtual horizon 19 here comprises a portion of the road segment 2a that the current map-matched location 7 is on, extending from the current map-matched location 7 to the next connection 3b. The associated total distance of the virtual horizon 19 is the travel distance along the road segment from the current map-matched location 7 to the connection node 3b. In this example, the connection node 3b marks a change in an attribute (e.g. speed limit), rather than a decision point such as a junction. A collection of one or more attributes are selected from the map data corresponding to the virtual horizon, which in some examples are attributes relevant to providing an Intelligent Speed Assist function on the vehicle. For example, the virtual horizon retrieval module 17 may select a speed attribute from the map data. In addition to the selected attribute(s), the virtual horizon retrieval module 17 determines a validity distance over which an attribute is valid (i.e. remains the same). A respective validity distance may be determined for each path of the virtual horizon 19. For the example shown in FIG. 3, the selected attribute is valid from the current map-matched location 7 to the end connection 3b for the current road segment 2a. Such a distance may be an actual travel distance along the road network, or a straight-line (i.e. line-of-sight) distance.

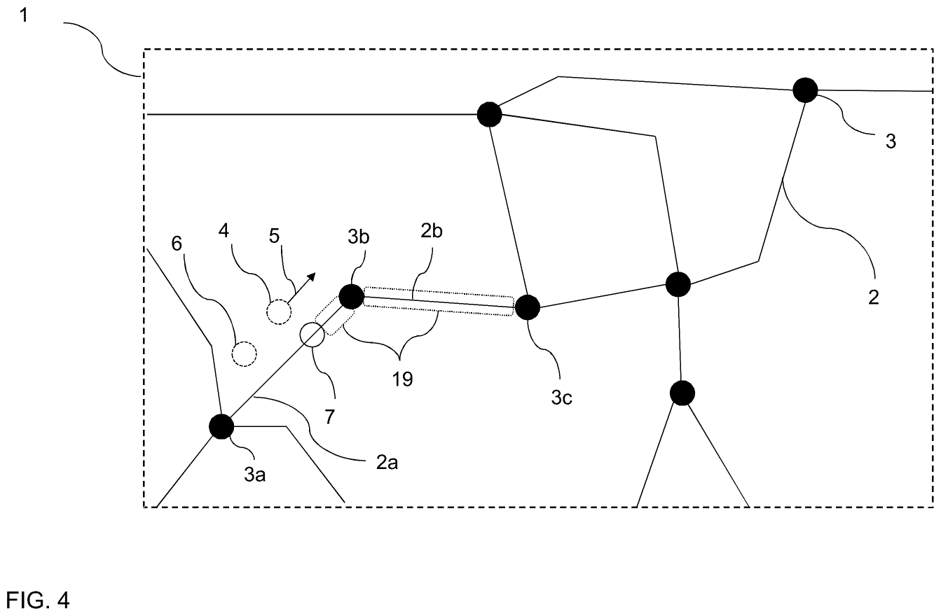

FIG. 4 shows the map area 1 of FIG. 1 with the same road network and probe data, but where the path ahead expansion module 14, has generated a different virtual horizon 19 from the current map-matched location 7 of vehicle that extends beyond the next connection 3b. This virtual horizon 19 comprises part of the current road segment 2a and also the next road segment 2b up to a destination connection 3c. As there are no junctions on this part of the road network, the vehicle is certain to traverse the entire path of the generated virtual horizon 19. The path of the virtual horizon 19 in FIG. 4 has a longer associated total distance compared to the total distance of the path in FIG. 3.

In some situations, the road segments making up a path may have identical attribute (e.g. speed limit) values. The virtual horizon simplifier module 15 may merge such road segments into a single road segment that has a merged road shape attribute describing the combined road shape of the merged road segments. The travel distance of the merged road segment is then the validity distance over which the collection of attributes (e.g., a speed limit attribute) remains unchanged. The merging of the road shape attribute may reduce the amount of information in the merged road shape, e.g. using the Ramer-Douglas-Peucker algorithm. This may allow a merged road shape, originally represented by many (e.g. a hundred) points to be simplified to a merged road shape with fewer (e.g. fifty) points, depending on the curves and straightness of the road segments to be merged.

In some variant embodiments, the validity distance may be represented by a validity time. It will be appreciated that a validity time could be used instead of a validity distance, e.g. based on an assumed average speed of the vehicle. When the validity time is reached, the vehicle is expected to have traversed the validity distance. Therefore, once the validity time elapses, new information may need to be displayed, or a new virtual horizon may need to be retrieved.

Different algorithms and/or factors may be used by the path ahead expansion module 14 to determine the extent of the virtual horizon. Some embodiments may support multiple algorithms, e.g. provided as user-selectable alternatives. In all cases, however, the virtual horizons that are generated by the path ahead expansion module 14 have dynamically variable total distances, which may depend on factors such as the road topology, road network usage patterns or current traffic speed data. This can be beneficial for enabling efficient communication between the server 101 and the client apparatus 102—e.g. reducing the amount of data that is transmitted that is never required by the vehicle, because it relates to road segments that the vehicle does not traverse.

The client 102 requests updated virtual horizons from the server 101 at intervals, which may be regular or irregular. The average request rate for updated virtual horizons can be affected by various factors, including the speed of the vehicle. It can also be affected by the total distances of the paths included in the virtual horizon, and by the probabilities of traversing the paths included in the virtual horizon. This can be seen in the formulas below, which indicate potential relationships between parameters and factors that can contribute to a process of generating and providing virtual horizons to the virtual horizon client 9.

A request rate can be defined by:

$$R = \frac{D}{v}$$

where R is the request rate for a single vehicle (e.g. an ISA client), D is the total distance (e.g. an average distance, or minimum path distance of paths in the virtual horizon), and vis the speed of travel for the vehicle along a path.

An estimated probability P_{T} of traversing a path which is included in the virtual horizon (i.e. not deviating from the virtual horizon) can be given by:

$${P}_{T} = {P}_{0}^{( \frac{D}{c} - k )}$$

where P₀ is the average probability of the vehicle traversing any individual turn which is included in the virtual horizon at a junction, D is the average total path distance, c is the average distance between two nodes in a local map area (i.e. a measure for node density in a map area), and k is the number of junctions where all possible paths that could be traversed next are included in the virtual horizon, i.e. the probability of deviating from a path included in the virtual horizon is 0 at that junction.

The average quantity of data S in the information exchange transmitting a virtual horizon can be calculated as:

$$S = {ks}_{n} ( \frac{D}{c} ) + {S}_{R}$$

where sₙ is the amount of map data per node (attribute data for each road segment), s_{R} is a fixed amount of data per request (the probe data plus some overhead), and k, D and care defined as above.

The amount of data S in the information exchange covers the case where the vehicle follows any path within the virtual horizon. If the vehicle deviates from the provided paths, the client on the vehicle triggers a new information exchange. These additional exchanges increase the overall amount of data.

S_{T} the total amount of information in the exchanges, including retransmissions caused by deviations from an expected path, can be written as:

$$\begin{matrix}{S}_{T} = S ( 1 + 2 ( 1 - {P}_{T} ) + 3 {( 1 - {P}_{T} )}^{2} + 4 {( 1 - {P}_{T} )}^{3} + … ) = S {\sum }_{n = 1}^{∞} {n ( 1 - {P}_{T} )}^{n - 1} \\ = \frac{S}{( 1 - {( 1 - {P}_{T} )}^{2} )} = \frac{S}{2 {P}_{T} - {P}_{T}^{2}}\end{matrix}$$

The request rate R may also require a correction factor calculated from the probability of traversal to obtain a total request rate R_{T}. This correction can be applied in the same way as for the total amount of information S_{T}.

$$\begin{matrix}{R}_{T} = R ( 1 + 2 ( 1 - {P}_{T} ) + 3 {( 1 - {P}_{T} )}^{2} + 4 {( 1 - {P}_{T} )}^{3} + … ) = R {\sum }_{n = 1}^{∞} {n ( 1 - {P}_{T} )}^{n - 1} \\ = \frac{R}{( 1 - {( 1 - {P}_{T} )}^{2} )} = \frac{R}{2 {P}_{T} - {P}_{T}^{2}}\end{matrix}$$

The estimated probability P_{T} of traversal of only paths contained in the virtual horizon impacts the request rate R in the same way as the amount of information S.

With an estimated probability P_{T} of 80%, the estimated increase in data rate would be 104%.

The total request rate doubles when the estimated probability drops to 30 percent. If a 10 percent rate increase is deemed acceptable, the estimated probability needs to be around 70 percent.

The total probability of traversal can be changed by providing alternative paths (higher k values increase P_{T} for the same total distance D), or by reducing the total distance.

Variation of parameters k and D also influences the average data volume per request and request rate.

Therefore, the total distance (i.e. the average path extent) and number of paths included can be altered in order to reach a target request rate and/or target volume of data per request.

The above shows that extending the total distance D is most beneficial for a virtual horizon for which the traversal time

$$( \frac{v}{D} = \frac{1}{R} )$$

is relatively short and the estimated probability P_{T} is relatively high. Efficient communication performance can therefore be provided by using the present embodiments, which provide a virtual horizon that has a dynamically variable total distance, dependent on factors such as the road topology, road network usage patterns or current traffic speed data—i.e. with the total distance D potentially different from one request to the next. Varying the number of alterative paths k included in the virtual horizon data is another related variable that can be controlled to optimise data exchange.

There are various ways that different embodiments may use to vary the virtual horizon responsive to one or more criteria. In every case, the extents of the paths of the virtual horizon are determined at least partly in dependence upon the respective probabilities that the vehicle will traverse each of the paths.

The criteria used by the path ahead expansion module 14 may include one or more of:
a probability threshold (for a single path or in aggregate across multiple paths);
a path-extent (i.e. distance) threshold;
a data volume threshold; and/or
a target request rate.

Examples of these different approaches are outlined below. Embodiments may use just one of these approaches, or may combine two or more, for determining a virtual horizon. The thresholds may be soft thresholds, rather than hard limits, in that the algorithms may allow a threshold to be crossed, but use the crossing of the threshold to trigger an action that determines the extent of a path, such as ceasing to extend the path further. A threshold may thus act as a target. A threshold may be predetermined, e.g. being hard-coded or user-configurable. It may remain constant over multiple horizon requests.

Minimum Path-Probability Threshold In some approaches, the path ahead expansion module 14 repeatedly extends a single most-probable path (MPP) until the addition of a road segment results in the combined probability of the vehicle traversing that path dropping below a threshold value. (This final road segment may be included in the virtual horizon, or not, depending on the implementation.) It extends the path by iteratively selecting, at each successive node along the path, out of all the road segments leading away from the node, the additional road segment having the highest probability of being traversed by the vehicle. The virtual horizon output by the path ahead expansion module 14 contains this single path and its associated attribute data (e.g. speed limit attribute).

The probabilities may be determined in advance or dynamically, and may be based on one or more factors such as road geometry, historic trip data, the current time, etc. If a path has a probability P_{P} and the probability of traversing an additional road segment has a probability of Pₛ, the combined probability of the path and the road segment equals P_{P} multiplied with Pₛ.

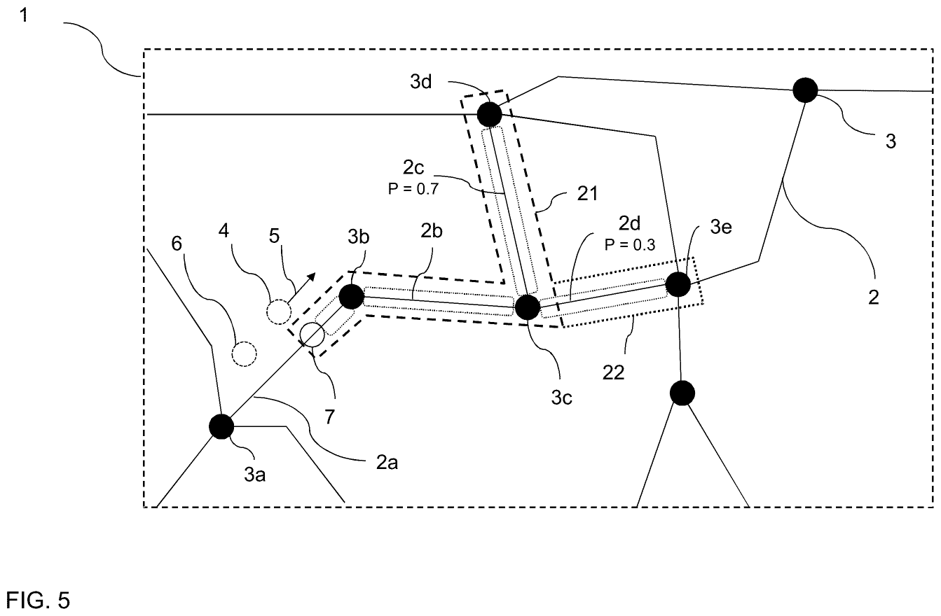

FIG. 5 shows the map area 1 and probe data of FIG. 1, with a first possible egress path segment 2c and a second possible egress path segment 2d from the connection point 3c to be considered for inclusion in a virtual horizon. These path segments follow on from a path including part of segment 2a starting from current location 7 up to connection point 3b, and segment 2b between connection points 3b and 3c. Starting from connection point 3c, the probability of the vehicle taking the first segment 2c is 0.7 (70%) and of taking the second segment 2d is 0.3 (30%). Therefore the probability of traversing the path from current location 7 to connection point 3d is 0.7, and the probability of traversing the path from current location 7 to connection node 3e is 0.3. (the path between current location 7 and connection point 3c has a 100% probability of traversal).

When applying a MPP approach, the path ahead expansion module 14 would select the first road segment 2c, as the more probable segment, for inclusion in the virtual horizon. If the path ahead expansion module 14 determines that the respective product of 0.7 and the probability assigned to each of the three possible road segments leading from the next connection 3d along this road segment 2c is below a predetermined threshold, it may stop and output the virtual horizon as having the three path segments 2a (of the portion of segment 2a that is forward from the current location 7), 2b and 2c.

In this way, the threshold value for the path probability, as well as the road segment probabilities themselves, affects the extent of the path that is included in the virtual horizon, with a lower minimum threshold increasing the average amount of data that will be returned for each request.

### Minimum Horizon-Probability Threshold

In a variant approach, instead of only considering the single most-probable path, the path ahead expansion module 14 can include zero, one, or more alternative paths in the virtual horizon (depending on the junction layout). The virtual horizon may be expanded by extending one or more paths by adding road segments to the path, until the probability of the vehicle taking any path that is within the virtual horizon (i.e. not turning onto a path that isn't included in the horizon before reaching the extent of the horizon) falls below a minimum horizon-probability threshold.

In the example shown in FIG. 5, the combined probability of a primary path 21 that includes the first road segment 2c from the second junction 3c, and an alternative path 22 that includes the second road segment 2d from the second junction 3c is one (i.e. 100%). However, if adding another segment to the end of the primary path 21 or to the end of the alternative path 22 would take the combined probability for the virtual horizon below a minimum horizon-probability threshold level, the path expansion process may stop expanding the virtual horizon (with that final road segment being included, or not, depending on the implementation).

Paths may be expanded with a breadth-first approach, adding more paths close to the map matched location, or a depth-first approach may be used, giving priority to growing the primary path. A minimum horizon-probability threshold for the virtual horizon may encourage the inclusion of more alternative paths, and different heuristics may be used for limiting the introduction of new alternative paths. This may be done by using a distance threshold, as explained below, or in any other appropriate way. A cost function may be used to determine how paths should be selected depending on the map topology and probabilities of traversing each path. For example, where the probability of traversing all paths following a starting point is low, it may be beneficial to use a shorter distance threshold, and include a greater number of paths in the virtual horizon.

A minimum threshold for the combined probability of the virtual horizon can impact the total distance associated with the virtual horizon. On a highway with infrequent exits, the total distance can be in the order of a few kilometres. In an urban environment with a high number of closely spaced junctions, the total distance may in the order of a 100 meters.

### Maximum Path-Distance Threshold & Minimum Horizon-Probability Threshold

Some methods to determine the extent of the virtual horizon using a maximum path-distance threshold.

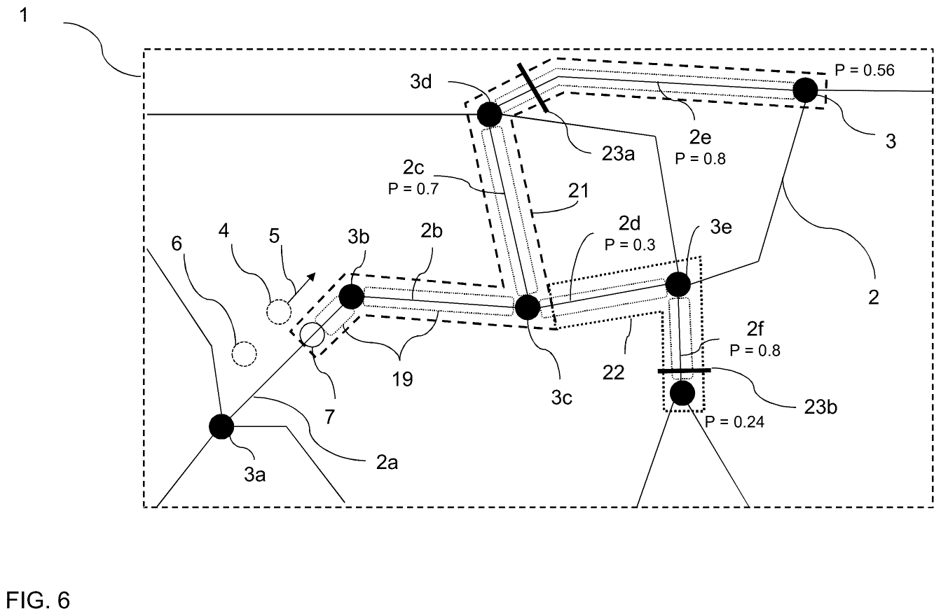

This is explained with reference to the example of FIG. 6, which is based on the map extract of FIG. 1. The virtual horizon service 8 generates the virtual horizon by extending the most probable path until a road segment is included that takes the extent of this path over a predetermined threshold distance value. This distance threshold is represented by a line 23 across the road segment 2e of highest probability leading from the connection 3d in the example of FIG. 6. (Note, however, that the exact geographical location of the threshold need not necessarily be determined in practice.) Depending on the junction (connection) density of the road network and traffic patterns, the combined probability of a primary path determined in this way may be below a minimum horizon-probability threshold for the virtual horizon. If so, the path ahead expansion module 14 may generate a first alternative path 22 and extend it until its extent also just exceeds the same threshold distance value, represented by a second line 23b in FIG. 6. If the combined virtual horizon probability for both paths is still below the minimum horizon-probability threshold, further alternative paths may be added iteratively until the combined probability crosses above the minimum horizon-probability threshold, at which point the expansion may stop.

In the example of FIG. 6, the probability of traversing the primary path 21 is 0.56 (56%), from the combined probability of road segments 2b (1.0), 2c (0.7) and 2e (0.8), while the alternative path 22 has a combined probability of 0.24 (24%) from road segments 2b (1.0), 2d (0.3) and 2f (0.8). The combined total probability of traversing a virtual horizon consisting of these two paths 21, 22 is then 0.8 (80%). If a minimum threshold probability for the virtual horizon were set to 0.7 (70%), say, the extracted map data in the virtual horizon shown in FIG. 6 would meet this requirement.

For a given virtual horizon request, the path ahead expansion module 14 continues to generate alternative paths until the combined probability of a primary path and the alternative paths exceeds the minimum horizon-probability threshold. This method generates a virtual horizon with a larger total distance for certain map areas while ensuring a minimum total distance is included in the virtual horizon in relatively dense parts of the road network such as in urban areas. This can reduce the risk of the vehicle turning onto a road for which the vehicle-based client 102 does not have any attribute information, but may come at the cost of increased data volumes per request.

### Maximum Data-Volume Threshold

The extent of the virtual horizon may be determined at least in part by one or more communication system parameters.

In some embodiments, the virtual horizon service 8 generates a virtual horizon in which the total amount of data sent in response to a request is lower than a maximum threshold data value. This can help to reduce the costs imposed by telecommunications providers for transporting responses to client requests, and/or make such costs more predictable. The threshold may be used only as an additional constraint on the selection of path segments to include in the horizon, or it may be used as a target, e.g. with path segments being added until the selected map data is close to the maximum data-volume threshold.

This approach may advantageously be used even in embodiments in which the virtual horizon always consists only of a single path (i.e. the most-probable path), but where the data volume varies depending on the number of bends (points) in the road shape (a polyline) and/or on the collection of attributes for the road segments. In such situations, a simplistic fixed-distance limit could result in unpredictable data volumes, potentially leading to unpredictable costs from telecommunications providers.

### Request-Rate Target

The extent of the virtual horizon may be determined at least in part by a target request rate—i.e. how often the client 9 sends requests for new virtual horizons to the server 8 (e.g. how many requests per minute or per hour). The actual request rate may depend on various factors, but an expected request rate may be determined from the extent of the virtual horizon and the expected traversal speed of the vehicle through the virtual horizon. Assuming a constant average path distance within the virtual horizon, the faster a vehicle travels through the road network, the higher the request rate will be.

A predetermined target request rate may be used to constrain the request rate from being too high and/or from being too low. It may thus be an bi-directional attractor rather than a uni-directional threshold.

The virtual horizon service 8 may determine an expected speed from the received probe data and determine a target distance for the virtual horizon response. It uses the target distance to generate the virtual horizon for the received probe data. The expected traversal speed may be the current speed of travel, the average speed of travel, the current average speed of travel, a historic speed of travel that may be obtained from the map data.

This target distance may be used as a maximum path-distance threshold in the algorithm disclosed above, or in any other appropriate way.

Any or all of these approaches could be combined in some embodiments, in order to enhance the selection of the sub-set of map data to include in the virtual horizon. The virtual horizon service 8 may determine a virtual horizon in which a trade-off between combined probability of traversal and the amount of data is stuck. For example, the optimal virtual horizon may be determined based on a weighted sum of the combined probability and the amount of data for each of several candidate virtual horizons.

In all methods above, a primary path and any alternative paths in the virtual horizon are generated based on the probabilities associated with outgoing road segments at connection locations. These “turn probabilities” may be assigned statically to each connection location, or they may be adjusted, e.g. based on a general direction of travel or other information, such as what path the vehicle took to arrive at the connection.

FIG. 7 shows a map-processing system 100′ that is similar to the system 100 of FIG. 2 except that the path ahead expansion module 14′ contains a probability estimator 20. The probability estimator 20 enables the path ahead expansion module 14′ to determine path segment probabilities dynamically, e.g. taking account of contextual factors such as the identity of the vehicle.

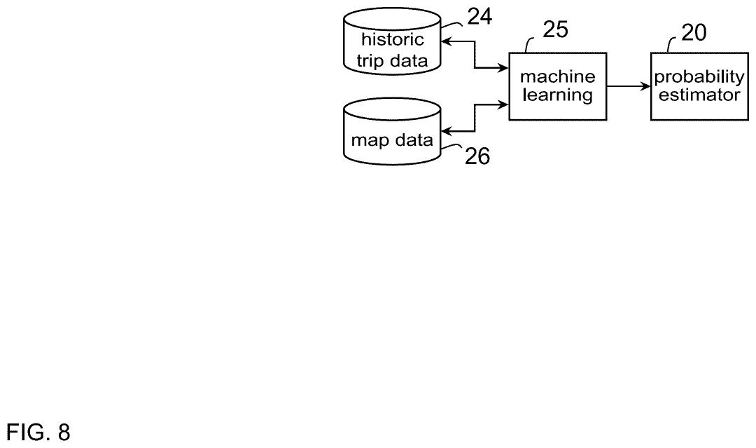

In some embodiments, the path ahead expansion module 14′ uses a probability estimator that comprises a model trained using machine learning. FIG. 8 shows a high level schematic of an exemplary machine-learning system for probability generation, which might be used to train the model. Historic trip data 24 and map data 26 are input to a machine-learning process 25, which trains a model (e.g. a neural network) to generate probabilities for possible paths. The model, or data derived from the model, is provided to (e.g. implemented within) the probability estimator 20. The probability estimator 20 can then use this to determine path probabilities in response to client requests.

Using machine learning can make it possible to determine the probability of a sequence of connected road segments being taken, rather than simply selecting the most likely option at each turn, which may provide a substantial improvement in the accuracy of path predictions and hence a reduction in the likelihood of the vehicle turning onto a road that is not included in the latest virtual horizon response sent to the client 102.

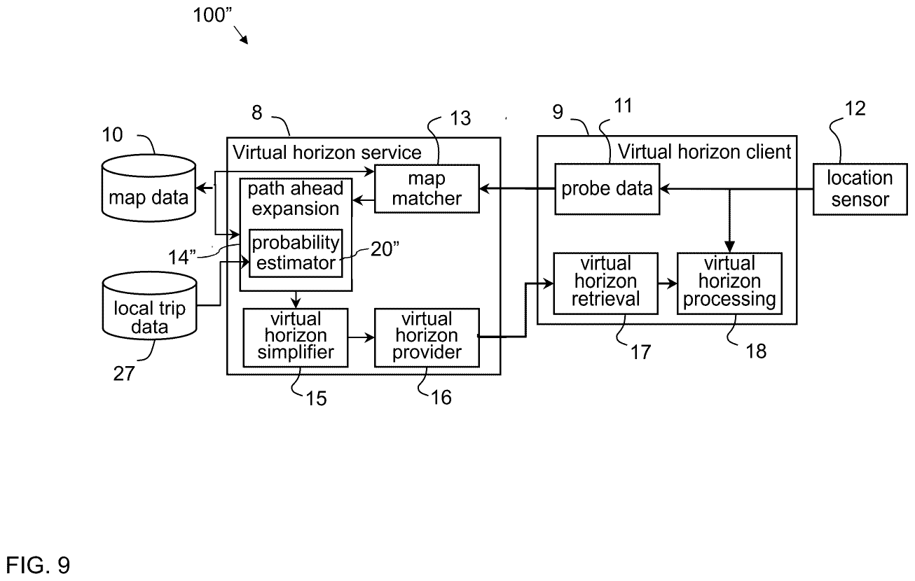

FIG. 9 shows a variant map-processing system 100″, similar to the system 100′ of FIG. 7 except that here the path ahead expansion module 14″ contains a contextualising probability estimator 20″, which can generate contextualised probabilities for road segments at connections, taking account of the identity of the vehicle or driver, and optionally other factors such as the time of day. The contextualising probability estimator 20″ can obtain trip data form a local trip data store 27 comprising personalized data based on trips made by a specific user or vehicle. General population-wide data may provide good predictions of paths that are generally likely to be traversed, but these may be improved further using personalized data where it is available for local trips, where previously traveled routes have associated preference information for each user. Making predictions informed by recurrent behavior enables the path ahead expansion module 14″ to better determine the paths ahead that should be included in the virtual horizon.

The generation of probabilities from local trip data 27 may be a deterministic process or may be based on machine learning. The path ahead expansion module 14″ may operate a model to adjust probabilities determined from population-wide predictions for contextual factors.

It will be appreciated by those skilled in the art that the invention has been illustrated by describing one or more specific embodiments thereof, but is not limited to these embodiments; many variations and modifications are possible, within the scope of the accompanying claims.

1. A method for sending map-related data to a client apparatus, wherein the map-related data is extracted from digital map data representative of a network of navigable path segments within a geographic area, the method comprising:
receiving probability data for a subject vehicle at a location, wherein, for each of a plurality of the path segments of the digital map data, the probability data represents a respective probability of the subject vehicle traversing the respective path segment;
determining a set of one or more paths, each path comprising one or more of the plurality of path segments and having a respective determined extent, wherein the determined extent of at least one of the paths of the set depends at least in part upon the received probability data;
extracting data, associated with the determined set of one or more paths, from the digital map data in accordance with the respective determined one or more path extents; and
sending the extracted data to the client apparatus.

2. The method of claim 1, wherein the set of one or more paths comprises a plurality of paths, and wherein the method comprises extracting, from the digital map data, data associated with each of the plurality of paths in accordance with the respective determined path extents.

3. The method of claim 2, wherein the extracted data contains only digital map data associated with the paths of the set of one or more paths.

4. The method of claim 1, comprising determining the extent of at least one path of the set of paths at least partly based on a minimum path-probability threshold.

5. The method of claim 4, comprising iteratively adding path segments to a path until the probability of the vehicle traversing the path crosses below the minimum path-probability threshold, and then ceasing to add any further path segment to the path.

6. The method of claim 1, comprising determining the extent of each of the set of paths at least partly based on a minimum horizon-probability threshold.

7. The method of claim 6, comprising determining the extents such that the probability of the vehicle traversing any path of the set for the respective extent of the path is such that the addition or the removal of one path segment from the set of paths would cause the probability to cross the minimum horizon-probability threshold.

8. The method of claim 1, comprising determining the extent of at least one path of the set of paths at least partly based on a maximum path-distance threshold.

9. The method of claim 8, comprising iteratively adding path segments to a path until the extent of the path crosses above the maximum path-distance threshold, and then ceasing to add any further path segment to the path.

10. The method of claim 1, comprising determining the maximum path-distance threshold at least partly in dependence upon a current speed of the vehicle.

11. The method of claim 1, comprising determining the membership and extents of the set of paths by applying a maximum path-distance threshold for each path and a minimum horizon-probability threshold for the set of paths.

12. The method of claim 11, comprising extending each path of the set of paths using an iterative extension process until the path has an extent such that the addition or the removal of one path segment would cause the extent of the resulting path to cross the maximum path-distance threshold, and adding paths to the set of paths until the probability of the vehicle traversing any path of the set for the respective determined extent is such that the addition or the removal of one path segment from the set of paths would cause the probability to cross the minimum horizon-probability threshold.

13. The method of claim 1, wherein the extents of each of the set of paths are determined at least partly based on a maximum data-volume threshold.

14. The method of claim 1, wherein the extents of each of the set of paths are determined at least partly based on a target request rate.

15. The method of claim 1, wherein the subject vehicle carries or comprises the client apparatus, and wherein sending the extracted data to the client apparatus comprises transmitting the extracted data to the subject vehicle from a remote server over a data network.

16. The method of claim 1, wherein the extracted data comprises attribute data for one or more road segments of the set of one or more paths.

17. The method of claim 1, wherein the extracted data comprises speed-limit data for the determined extent of each path of the set of one or more paths.

18. The method of claim 1, comprising receiving probe data from the subject vehicle over a network, determining the set of paths at least partly in dependence upon the received probe data, and transmitting the extracted data to the vehicle.

19. A system, comprising:
at least one processor configured to send map-related data to a client apparatus, wherein the map-related data is extracted from digital map data representative of a network of navigable path segments within a geographic area, and wherein the sending includes:
receiving probability data for a subject vehicle at a location, wherein, for each of a plurality of the path segments of the digital map data, the probability data represents a respective probability of the subject vehicle traversing the respective path segment;
determining a set of one or more paths, each path comprising one or more of the plurality of path segments and having a respective determined extent, wherein the determined extent of at least one of the paths of the set depends at least in part upon the received probability data;
extracting data, associated with the determined set of one or more paths, from the digital map data in accordance with the respective determined one or more path extents; and
sending the extracted data to the client apparatus.

20. A non-transitory computer-readable storage medium storing instructions which, when executed by at least one processor, cause the at least one processor to perform a method for sending map-related data to a client apparatus, wherein the map-related data is extracted from digital map data representative of a network of navigable path segments within a geographic area, the method comprising:
receiving probability data for a subject vehicle at a location, wherein, for each of a plurality of the path segments of the digital map data, the probability data represents a respective probability of the subject vehicle traversing the respective path segment;
determining a set of one or more paths, each path comprising one or more of the plurality of path segments and having a respective determined extent, wherein the determined extent of at least one of the paths of the set depends at least in part upon the received probability data;
extracting data, associated with the determined set of one or more paths, from the digital map data in accordance with the respective determined one or more path extents; and
sending the extracted data to the client apparatus.
